(19) United States
(12) Patent Application Publication
(10) Pub. No.: US 2014/0043469 A1
(43) Pub. Date: Feb. 13, 2014

(54) CHROMATIC SENSOR AND METHOD

(71) Applicant: Carl Zeiss Industrielle Messtechnik GmbH, Oberkochen (DE)

(72) Inventors: Thomas ENGEL, AALEN (DE); Johannes WINTEROT, JENA (DE); Norbert KERWIEN, MOEGGLINGEN (DE)

(73) Assignee: Carl Zeiss Industrielle Messtechnik GmbH, Oberkochen (DE)

(21) Appl. No.: 13/960,318

(22) Filed: Aug. 6, 2013

Related U.S. Application Data
(63) Continuation of application No. PCT/EP2012/065477, filed on Aug. 7, 2012.
(60) Provisional application No. 61/680,454, filed on Aug. 7, 2012.

(51) Int. Cl. G01N 21/88

(52) U.S. Cl. CPC G01N 21/88
USPC 348/135

(57) ABSTRACT

An apparatus for inspecting a measurement object, comprising a workpiece support for supporting the measurement object, and a measuring head carrying an optical sensor. The measuring head and the workpiece support are movable relative to one another. The optical sensor has an objective and a camera for capturing an image of the measurement object along an imaging beam path. The objective has a light entrance opening and a light exit opening, a diaphragm and a multitude of lens-element groups arranged in the objective between the light entrance opening and the light exit opening along a longitudinal axis of the objective. At least two lens-element groups are displaceable parallel to the longitudinal axis. The apparatus also has an illumination device for illuminating the measurement object along an illumination beam path, and a chromatic assembly that can selectively be introduced into the illumination beam path and/or the imaging beam path.

### CROSS-REFERENCE TO RELATED APPLICATIONS

This application is a continuation of International PCT application No. PCT/EP2012/065477, filed Aug. 7, 2012. This application also claims the priority of U.S. provisional application No. 61/680,454, filed Aug. 7, 2012. The entire contents of these priority applications are incorporated herein by reference.

### BACKGROUND OF THE INVENTION

The present invention relates to an apparatus for inspecting a measurement object, comprising a workpiece support for supporting the measurement object, comprising a measuring head carrying an optical sensor, wherein the measuring head and the workpiece support are movable relative to one another, wherein the optical sensor has an objective and a camera, which is designed to capture an image of the measurement object through the objective along an imaging beam path, wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, wherein at least two lens-element groups are displaceable parallel to the longitudinal axis, and wherein the apparatus has an illumination device for illuminating the measurement object along an illumination beam path.

The use of optical sensors in conjunction with coordinate measuring machines makes it possible in many cases to measure geometrical properties of a measurement object very rapidly. One disadvantage of known coordinate measuring machines comprising optical sensors heretofore has been that the optical sensors are limited to specific measurement tasks and specific workpiece properties. The optical sensors are generally optimized for a specific type of measurement task, for instance with regard to the achievable measurement accuracy or the measurement range. Problems can be posed for example by workpieces which have large height differences parallel to the optical axis of the sensor. In part, different optical and/or tactile sensors are used in order to be able to react flexibly to different measurement requirements, wherein the individual sensors in each case perform only part of the overall measurement task. In general, each individual sensor is optimized towards a specific measurement task. Primarily optical sensors therefore have a respective individual optics which is well suited to a specific purpose of use and is less well suited to other purposes.

By way of example, coordinate measuring machines comprising a white light sensor have been proposed. Such a coordinate measuring machine is disclosed by the document DE 103 40 803 A1, for example.

Most of the confocal white light sensors used are point sensors. These sensors achieve a depth resolution in the range of approximately 10 nm. Such sensors are used to perform precise measurements along scanning paths on a measurement object. Often, measurement results of these sensors are combined with camera images having lower depth resolution. The advantages of fast surface information and very accurate depth information can be combined in this way. Embodiments in which a plurality of measurement channels or measurement points are arranged alongside one another are also known. However, the individual measurement points generally have a relatively large lateral distance, with the result that a complete linear measurement is not possible.

On the other hand, it has also been proposed to direct a line of white light onto a measurement object. In this case, the different colors of the light within the available spectrum are imaged into different depths. The light reflected by the measurement object is subsequently analyzed spectrally and a respective measurement point is assigned the depth value as measurement value for which the reflected spectral light distribution has its maximum value.

As explained in the document DE 103 40 803 A1, such white light sensors are arranged in addition to the other optical sensors on the carrier structure of the coordinate measuring machine.

The provision of different sensors for different measurement tasks in a coordinate measuring machine makes possible a high flexibility in conjunction with a high measurement accuracy. The high costs for the provision of the numerous sensors with in each case a dedicated optics adapted to the purpose of use of the sensor are disadvantageous. Furthermore, the large number of sensors with in each case a dedicated optics require a relatively large structural space in the coordinate measuring machine, which restricts the measurement volume and causes further costs.

There is a desire to provide an optical coordinate measuring machine which can perform a large range of optical measurement tasks in conjunction with comparatively low costs. Accordingly, it is an object of the present invention to specify a corresponding coordinate measuring machine and a corresponding method.

### SUMMARY OF THE INVENTION

According to the invention, it is therefore provided an apparatus for inspecting a measurement object, comprising a workpiece support for supporting the measurement object, comprising a measuring head carrying an optical sensor, wherein the measuring head and the workpiece support are movable relative to one another, wherein the optical sensor has an objective and a camera, which is designed to capture an image of the measurement object through the objective along an imaging beam path, wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, wherein at least two lens-element groups are displaceable parallel to the longitudinal axis, and wherein the apparatus has an illumination device for illuminating the measurement object along an illumination beam path, wherein the apparatus furthermore has a chromatic assembly, and wherein the apparatus is designed in such a way that the chromatic assembly can selectively be introduced into the illumination beam path and/or the imaging beam path.

In this way, it becomes possible to introduce a longitudinal chromatic aberration into the optical system of the objective in a targeted manner. In this way, a distance measurement in the manner of a white light sensor becomes possible, wherein the possibilities of the objective for setting the region or operating distance to be examined are maintained.

In particular, there is passage through the chromatic assembly on the path from the reflected-light illumination device to the measurement object, and also on the imaging path from the measurement object to the detector. In particular, the chromatic assembly can thus be introduced into the illumination beam path and into an imaging beam path running from the measurement object through the objective, or in other words lens or lens assembly, to the camera. In this case, the spectrum for illumination is focused via an intermediate focus onto a preferably confocal diaphragm and from there is imaged by means of the chromatic assembly in the direction toward the measurement object. As a result, the focus is then realized at different object depths in a wavelength-dependent manner. On the path from the measurement object to the camera, the longitudinal chromatic aberration is then impressed again in the opposite direction and thus corrected. All wavelengths then meet again at the same focal point in the preferably confocal diaphragm and from there are directed by an intermediate optics onto the camera or a spectrally resolving element (spectrometer) and the spectrum is measured there. Consequently, the chromatic assembly can be introducible in particular into the illumination beam path and into an imaging beam path from the measurement object through the objective to the camera.

As an alternative, in addition to the chromatic assembly which can be introduced into the illumination beam path, a second chromatic assembly can also be introducible into the imaging beam path from the measurement object through the objective to the camera. The chromatic assembly in the illumination beam path can then be introduced only into the illumination beam path, but not into the imaging beam path. Consequently, as an alternative, a chromatic assembly can be introduced into the illumination beam path and a further chromatic assembly can be introduced into the imaging beam path.

It can also be provided that the chromatic assembly is arranged in the imaging beam path and the measurement object is illuminated such that the illumination beam path runs through the introducible chromatic assembly. By way of example, the measurement object can be illuminated directly with a white light or multichromatic light. The measurement object then scatters or reflects the incident light. In the imaging beam path, the beam of rays detected by the objective then passes through the chromatic assembly. In configurations of the invention it can be provided that the diaphragm is arranged on the image side of the chromatic assembly. On account of the chromatic assembly, the beam of rays has a chromatic aberration upon passing through the diaphragm. Consequently, each wavelength of the light has a different position for the intermediate focus. A specific spectral component is therefore filtered out by the diaphragm. Since the position of the intermediate focus depends not only on the wavelength but also on the distance between the object point, i.e. the corresponding surface of the measurement object, and the chromatic assembly, the distance of the respective object point can be deduced from the spectral component filtered out by the diaphragm. In order to obtain absolute distance values, the corresponding relationship between filtered spectral component and distance can either be stored by prior calibration. However, it is also possible to arrange a reference object having at least one known distance in the detection region of the sensor.

Furthermore, it also becomes possible, for example, to set a variable depth resolution of the white light sensor by means of the diaphragm of the objective, which can be an aperture stop, for example. Since the chromatic aberration, in particular the longitudinal chromatic aberration, can increase in regions of a lens element at a large radial distance from an optical axis, the longitudinal chromatic aberration of the overall system can be influenced by the position of the aperture stop. With a wide open aperture stop, radially outlying portions of the lens elements are also illuminated, such that the chromatic vertex focal length difference increases overall. With a more closed aperture stop, a beam path is effected only through a part lying near an optical axis on the respective lens element. The vertex focal length difference of the overall system is then smaller. In this way, it is possible to set the segment via which the spectrum of the incident light is split along the longitudinal axis or the optical axis of the objective. Of course, it is also possible to vary this segment by varying the position of the optical elements of the chromatic assembly with respect to one another or, for example, exchanging the chromatic assembly.

The illumination itself can either be effected with a full white-light spectrum for optimizing the measuring capacity. Alternatively, however, it is conceivable, in principle, to use only part of the possible spectrum for an individual measurement, in order to be able to correct chromatic magnification differences, also known as transverse chromatic aberrations. This will be discussed in even greater detail below.

In particular, the proposed invention makes it possible, in the case of using a color-selective camera capable of outputting a concrete color value for each measurement point, to carry out a whole-area measurement. However, this is just one possible option. As explained below, it is also possible to use a line focus with a scanning movement of the measuring head. In particular, the proposed invention makes it possible, moreover, to carry out an integration of a sensor that effects measurement in the manner of a white light sensor into an existing optical system of an optical sensor which can be used to measure observations on the same axis as with a camera. As a result, not only is a more compact construction of the overall system achieved; with the white light sensor it is also possible to detect the same measurement volume as with the corresponding camera.

Furthermore, in this way it is possible to achieve, for the measurement with the white light sensor, a greater depth of field than is usually the case. Since the chromatic assembly is introduced into the objective separately for the measurement in the manner of a white light sensor, the longitudinal chromatic aberration brought about by the chromatic assembly can be defined. In particular, the longitudinal chromatic aberration can be brought about in a targeted manner to a large extent. Each lens-element group of the object is usually chromatically corrected in each case by itself in such a way that no significant chromatic aberration, whether as longitudinal aberration or transverse chromatic aberration, occurs. This is necessary not least in order to obtain a high imaging quality on the camera. With the chromatic assembly, however, this chromatic aberration can now be introduced into the beam path selectively to a suitably high extent.

In a further refinement of the invention it is provided that each of the lens-element groups has in each case at least two lens elements, wherein each of the lens-element groups is corrected with regard to a longitudinal chromatic aberration, and wherein the chromatic assembly is configured in such a way that it brings about a defined longitudinal chromatic aberration.

In this case, a “longitudinal chromatic aberration” is understood to mean, in the manner customary to the person skilled in the art, in other words a wavelength-dependent vertex focal length difference along a respective optical axis. In this way, the objective of the apparatus can be designed in such a way that it is free of longitudinal chromatic aberrations. In particular, in the design of an objective it is advantageous if each lens-element group per se can be configured as corrected with regard to a longitudinal chromatic aberration, for example by means of a suitable choice of the materials of the lens elements and the curvatures of the surfaces. In the case of an objective corrected in this way, it then becomes possible, by means of the chromatic assembly, to introduce a previously defined or predefined longitudinal chromatic aberration into the objective in a targeted manner. In particular, the otherwise undesirable longitudinal chromatic aberration can be brought about by means of the chromatic assembly deliberately to a great extent in a manner necessary for the white light distance measurement. The greater the defined longitudinal chromatic aberration of the chromatic assembly, the greater becomes as it were the depth of field of a white light sensor that effects measurement in this way, that is to say that the segment dimension parallel to the longitudinal axis, in which a surface of the measurement object can be identified, becomes greater. Under certain circumstances, however, it may also be desired to limit this segment dimension to a specific length, in order to maintain a certain accuracy or resolution of the white light sensor. If the incident spectrum covers a range of 300 nm, for example, it can be understood that the resolution of a sensor that effects measurement with this spectrum is higher if the vertex focal length difference between the lowest and highest wavelengths parallel to the longitudinal axis is 10 mm in comparison with the case where it is 30 mm, for example. Of course, the accuracy ultimately also always depends on a spectrometer or optical sensor that determines the wavelength maximum of the reflected light. However, a basis for this accuracy is already established here in the choice of the longitudinal chromatic aberration of the chromatic assembly.

In a further refinement of the invention it can be provided that the apparatus has at least four lens-element groups, wherein a first lens-element group from the at least four lens-element groups is arranged in a stationary fashion in the region of the light entrance opening, and wherein the diaphragm and a second lens-element group, a third lens-element group and a fourth lens-element group from the at least four lens-element groups are displaceable relative to the first lens-element group along the longitudinal axis, wherein the second lens-element group is arranged between the first lens-element group and the diaphragm, and wherein the third and fourth lens-element groups are arranged between the diaphragm and the light exit opening.

The provision of such an objective makes it possible to retrofit the existing optical coordinate measuring machine by replacing the optics, in order in this way to achieve the properties and advantages explained below. Such an objective in which at least separate lens-element groups are arranged on a common optical axis has a first lens-element group (as viewed from the light entrance opening or front side), which is stationary. The lens-element groups together generate an image on an image sensor coupled via the interface of the objective. On account of the individual displaceability of the three lens-element groups, the new objective can be set to different imaging conditions flexibly. This makes possible, in particular, a variable setting of the magnification and a variable setting of the operating distance. In particular, it is possible to provide a telecentric objective that operates telecentrically over the entire setting range of the operating distance and of the magnification. The individual adjustability of the three lens-element groups furthermore makes it possible to realize a constant magnification only in the entire setting range for the operating distance or a constant focusing to a specific operating distance over the entire magnification range. These properties make it possible for the first time to measure a measurement object having great height differences parallel to the optical axis of the objective or the longitudinal direction with constant parameters, without the optical sensor as such having to be moved nearer to the measurement object or further away from the measurement object. This last makes possible a very fast measurement of a multitude of measurement points. The stationary first lens-element group furthermore has the advantage that the “disturbing contour” of the optical sensor in the measurement volume is always the same. The risk of the sensor colliding with the measurement object is reduced. It is no longer necessary to provide changeable optics.

In a further refinement of the invention it can be provided that the chromatic assembly can be introduced between the first lens-element group and the second lens-element group.

On account of establishing the first lens-element group and a defined minimum distance between the movable second lens-element group and the first lens-element group, it is possible to provide a clearance between the first lens-element group and the second lens-element group, into which clearance optical elements can be coupled. It is thus possible, for example, by means of a beam splitter between the first lens-element group and second lens-element group, to couple any arbitrary further sensors and/or illuminations which are intended to use only the first lens-element group of the objective. On account of the clearance, in this way it also becomes possible in a particularly simple manner to provide a location for coupling in the chromatic assembly. In principle, however, the chromatic assembly for bringing about the defined longitudinal chromatic aberration can also be introduced at some other suitable point in the objective.

In a further refinement of the invention it can be provided that the chromatic assembly can be introduced into the illumination beam path between the reflected-light illumination device and the multitude of lens-element groups.

The chromatic assembly is introduced into the illumination beam path—as viewed from the reflected-light illumination device—“in front” of the multitude of lens-element groups of the objective. In particular, the chromatic assembly can be introducible at the light exit opening. However, it is then situated in the illumination beam path. The chromatic assembly can thus also serve as an intermediate assembly in the beam path to the camera. The illumination beam path and the imaging beam path to the camera then run confocally and coaxially through the objective. The imaging scale that can be varied by means of the objective then still has the advantage of adapting the operating range of the white light sensor by means of a change in the magnification, which leads to a change in the aperture. By means of an adjustment of the operating distance, the operating range would then be spatially shifted.

It can also be provided that the chromatic assembly can be introduced into the imaging beam path on the image side of the objective. In particular, it can then additionally be provided that a further diaphragm can be introduced into the imaging beam path on the image side of the chromatic assembly.

In a further refinement of the invention it can be provided that the chromatic assembly has at least one refractive optical element, wherein the at least one refractive optical element is a spherical or cylindrical lens element, and in particular wherein the chromatic assembly has a plurality of refractive optical elements constructed in the manner of a Kepler telescope or constructed in the manner of a Galilean telescope.

The construction of a Kepler telescope and of a Galilean telescope is known in principle to the person skilled in the art. Differences between the two types of telescopes are that the Kepler telescope generates an inverted real intermediate image of a viewed object, which is viewed through an eyepiece. By contrast, an erect virtual image is viewed in the Galilean telescope. A further advantage of the Kepler telescope may be, moreover, that a larger field of view is provided.

In a further refinement of the apparatus it can furthermore be provided that the chromatic assembly has at least one diffractive optical element.

The fundamental requirement made of the chromatic assembly is that different colors of the light or different wavelengths are imaged sharply in different object planes. Firstly, spherical and/or cylindrical optics are suitable for the construction of the chromatic assembly. The optics can be embodied either as refractive or as diffractive. In principle, holographic optical elements are also conceivable. Combinations of refractive and diffractive elements are likewise possible. One advantage of a diffractive optical element is that, in the design of the diffractive structure, the dispersion and thus the spectral splitting can be set in a targeted manner in wide ranges. With the use of refractive optical elements, the dispersion is dependent on the material chosen, such that the splitting can be set only by means of the choice of material and the geometrical design of the front and rear surfaces of the respective optical element, which enables the targeted setting of the spectral configuration only within narrower limits. In principle, it is conceivable to provide the chromatic assembly as a Kepler telescope having a spherical and/or cylindrical optics, as a Galilean telescope having a spherical and/or cylindrical optics, as an arrangement having both refractive and diffractive optical elements, or else as an arrangement having a plurality of diffractive optical elements.

In a further refinement of the invention it can be provided that the illumination device is a reflected-light illumination device for illuminating the measurement object through the objective.

It can furthermore be provided that the apparatus furthermore has a cylindrical refractive optical element and/or a slit diaphragm in order to shape a beam of rays emitted by the reflected-light illumination device to a line focus.

It can also be provided that a slit diaphragm together with the chromatic assembly can be introduced into the illumination beam path and/or the imaging beam path. In principle, it can also be provided that the reflected-light illumination device is an element of the chromatic assembly.

In this way, by means of the reflected-light illumination device it becomes possible, in particular, to provide a line focus and in this way to provide the white light sensor as a line scanner. It becomes possible to detect an entire line on the measurement object by means of the white light sensor and to cause this line to move over the measurement object by means of a relative movement between measuring head and measurement object, in order thus to enable an areal detection of the surface of the measurement object. In order to produce a line focus, it is possible to influence the illumination of the reflected-light illumination device at different locations in the beam path. By way of example, it is possible to introduce a slit diaphragm into the reflected-light illumination device. Provision can also be provided for introducing such a slit diaphragm together with the chromatic assembly into the apparatus. Provision can also be made for a width of the slit diaphragm to be adjustable. In this way, the slit diaphragm can be adapted to the measurement task and the required resolution or irradiance. Furthermore, it is possible to introduce a cylindrical optics or a focusing optics, in order to generate a bright line from the light of the reflected-light illumination device. Compared with the use of a slit diaphragm by itself, it is thereby possible to increase the radiant intensity of the line focus and thus to shorten the measurement time for capturing an image. Under certain circumstances, however, it may be necessary to have to provide in turn a corresponding cylindrical optics at the receiver end upstream of an optical sensor or spectrometer, before a spectral evaluation can be effected. Finally, it can also be provided that together with the chromatic assembly an illumination device is coupled in, which provides the desired areal or linear illumination. This can be effected directly by coupling in with the chromatic assembly into the objective. However, it can also be provided, for example, that the chromatic assembly has a mirror that couples in the light from the reflected-light illumination device of the chromatic assembly.

In a further refinement of the apparatus it can be provided that the camera is designed in such a way that it provides a spectral evaluation for each pixel.

However, it can also be provided that the apparatus furthermore has a spectrometer. In this case, for this purpose it is possible to provide a beam splitter, which is arranged in the objective in such a way that it directs light incident through the objective both onto the spectrometer and onto the camera.

The sensor unit of the white light sensor proposed here must be able to supply a spectral evaluation or information for every point of an illuminated line or of an illuminated areal image field. Cameras which can supply spectral information for every pixel of their optical sensor are known. They enable an areal chromatic image capture and evaluation. One example is the camera series “true PIXA” from Chromaseus GmbH, Konstanz, Germany.

In the case of any line sensor, the spectral detection can be effected by means of a spectrometer. The line incident on the measurement object is reflected and is incident on the input diaphragm or the input slit of the spectrometer. The light that passes through the input diaphragm is then directed onto a dispersive element. By way of example, prisms, gratings or generally diffractive structures are appropriate as a dispersive element. At least one diffractive element can be provided. It has the task of splitting the light of the line into its spectral constituents in a transverse direction with respect to the line. This gives rise to a two-dimensional light distribution, which can then be captured in a spatially resolved manner by means of an areal detector. For each measurement location of the line, the associated spectrum is evaluated, and compared with the incident spectrum, and a difference spectrum is analyzed. A maximum of the difference spectrum is then assigned to a distance in the corresponding surface of the measurement object with respect to the apparatus. In the case of a plurality of local maxima, in the spectral sequence of the maxima, e.g. from near to far, it is also possible to determine the distance of a plurality of surfaces, situated one behind another, of at least partly transparent objects from a captured spectrum. For an evaluation, the reflected spectrum is typically normalized to the incident spectrum and the maximum value is sought in the relative unit that arises. The advantage here is that in this way there is no need to make special requirements of the light source chosen or the light sources chosen. It is possible to employ any spectrum. It may furthermore be advantageous also to measure the spectrum of the incident light simultaneously with the spectrum of the reflected light or before or after the capture of the reflected spectrum, in order to be able to compensate for aging phenomena at the light sources.

In a further refinement of the apparatus it can be provided that the apparatus has a plurality of chromatic assemblies, wherein a single one or more of the plurality of chromatic assemblies can selectively be introduced into the illumination beam path and/or the imaging beam path, and wherein each chromatic assembly is configured in such a way that it brings about a different longitudinal chromatic aberration.

This makes it possible to couple different chromatic assemblies into the apparatus. This can be made possible, for example, in order to provide different “depths of field” of the white light sensor which are generated by different longitudinal chromatic aberrations.

In a further refinement of the apparatus it can be provided that the apparatus is a coordinate measuring machine and has an evaluation and control unit, which is designed to determine spatial coordinates at the measurement object in a manner dependent on a position of the measuring head relative to the workpiece support and in a manner dependent on sensor data of the optical sensor.

In this way it becomes possible to combine different types of sensor in just one apparatus having a compact construction.

In a further refinement of the apparatus it can be provided that the apparatus has an evaluation and control unit, which is designed in such a way that it takes into account, during an evaluation, imaging aberrations that occur, in particular an inclination of spectral lines relative to the longitudinal axis, said inclination being brought about by a transverse chromatic aberration of the objective and of the chromatic assembly.

In general, transverse chromatic aberrations or vertex focal length differences transversely with respect to the direction of propagation or optical axis cannot be completely corrected in the context of a simple optical system that is to be produced cost-effectively. This leads to the effect that not only do the images of the different colors or wavelengths lie at different depths along the longitudinal direction, which is desired in principle, but also a lateral scaling is present in the image. This has to be taken into account in a subsequent evaluation. This aberration image can be described mathematically by polynomials. It is thus possible to correct the effect on the captured image.

As a result of the transverse chromatic aberration, for example, red spectral components are imaged with a smaller imaging scale than blue spectral components. This effect can either be determined computationally or be calibrated by means of a correspondingly configured measurement object. Suitable calibration objects are pure amplitude objects of known geometry which have no or only a minimal interaction with the light color or wavelength dependence.

As an effect of the transverse chromatic aberration, the spectral lines for a specific measurement point are no longer parallel to the longitudinal direction, but rather inclined with respect to the longitudinal direction in accordance with the effect of the transverse chromatic aberration. In this case, the spectral lines need not run rectilinearly; they can also have a curved course. With knowledge of the optical elements involved, the inclination or the expected course can be calculated and taken into account.

In a further refinement it can be provided that a first lens-element group from the at least four lens-element groups is arranged in a stationary fashion in the region of the light entrance opening, and that the diaphragm and a second lens-element group, a third lens-element group and a fourth lens-element group from the at least four lens-element groups are displaceable relative to the first lens-element group along the optical axis, wherein the second lens-element group is arranged between the first lens-element group and the diaphragm, and wherein the third and fourth lens-element groups are arranged between the diaphragm and the light exit opening.

In this way, an objective is provided in which at least four separate lens-element groups are arranged on a common optical axis. The first lens-element group (as viewed from the light entrance opening or front side) is stationary. Behind it there follow along the optical axis three further lens-element groups, which are in each case displaceable relative to the first lens-element group along the optical axis. Selectively, the objective in some refinements has a fifth lens-element group, which is arranged in the region of the light exit opening and is stationary. The lens-element groups together generate an image on an image sensor coupled to the objective via the interface. On account of the individual displaceability of the three lens-element groups, the new objective can be set to different imaging conditions very flexibly. As explained below on the basis of a preferred exemplary embodiment, the new objective makes possible, in particular, a variable setting of the magnification and a variable setting of the operating distance. In the preferred exemplary embodiments, the new objective is telecentric over the entire setting range of the magnification and over the entire setting range of the operating distance, which can be achieved very well with the aid of the axially displaceable diaphragm. The individual adjustability of the three lens-element groups furthermore makes it possible to realize a constant magnification over the entire variation range of the operating distance or a constant focusing to an operating distance over the entire magnification range. These properties make it possible for the first time to measure a measurement object having great height differences parallel to the optical axis of the objective with constant parameters, without the optical sensor as such having to be moved nearer to the measurement object or further away from the measurement object. This last makes possible very fast measurements at a multitude of measurement points. The stationary first lens-element group furthermore has the advantage that the “disturbing contour” of the optical sensor in the measurement volume of the coordinate measuring machine is always the same. The risk of the sensor colliding with the measurement object is reduced. Furthermore, the variable settability makes it possible to dispense with changeable optics, which were used in part in previous coordinate measuring machines in order to perform different measurement tasks.

In a further refinement, the first and second lens-element groups together form a focal point lying between the second and third lens-element groups, wherein the control curve for the diaphragm and the control curve for the second lens-element group are coordinated with one another such that the diaphragm is always arranged at the focal point.

This refinement ensures for the new objective, despite the flexible variation possibilities, an at least object-side telecentricity over all magnifications and operating distances. The object-side telecentricity is advantageous in order to determine in particular the depth of bores, projections or recesses on a measurement object because the “view” of the measurement object is largely constant despite the different operating distances in these cases. A perspective distortion of the measurement object is advantageously avoided by virtue of an object-side telecentricity.

In a further refinement, the diaphragm has a variable diaphragm aperture, which preferably varies in a manner dependent on the position of the diaphragm along the optical axis.

In this refinement, the new objective has a further degree of freedom, namely the aperture of the diaphragm. This makes it possible to vary the numerical aperture of the objective and thus to vary the achievable resolution of the objective. In preferred exemplary embodiments, the abovementioned control curves including the individual control curve for the diaphragm aperture are embodied such that the objective offers an operating mode with a constant image-side aperture over different operating distances. This operating mode is advantageous in order to be able to operate with a constantly high measurement accuracy over different operating distances.

In the preferred exemplary embodiments, the diaphragm is situated centrally with respect to the optical axis, to be precise with a centering error that is less than 20 μm and is preferably less than 10 μm. The diaphragm is preferably an iris diaphragm that is drivable individually in a motor-operated manner, wherein the driving is effected using a control curve belonging to the set of curves mentioned above. These exemplary embodiments enable a simple implementation and a constantly high measurement accuracy over the entire operating range.

In a further refinement, the objective has a multitude of slides and motor-operated drives, wherein the second, third and fourth lens-element groups and the diaphragm are in each case coupled to a dedicated slide that is adjustable along the optical axis, and wherein the slides are individually movable with the aid of the motor-operated drives.

In this refinement, the elements that are adjustable along the optical axis are in each case coupled to a dedicated drive. In some exemplary embodiments, the drive is a stepper motor, which preferably operates in full-step operation since this results in a low heat input into the objective. The refinement enables a modular and comparatively cost-effective realization.

In a further refinement, the first lens-element group has a positive refractive power. Preferably, the second lens-element group has a negative refractive power, the third lens-element group has a positive refractive power and the fourth lens-element group has a negative refractive power.

In practical experiments this refinement has proved to be very advantageous for achieving a compact design and a small disturbing contour of the objective in the measurement volume of the new coordinate measuring machine.

In a further refinement, there is a clearance in the objective body between the first and second lens-element groups, a beam splitter preferably being arranged in said clearance. In the preferred variant, there is situated at the level of the beam splitter a further interface on the objective body, via which further interface a defined illumination can be coupled into the objective and/or an image generated only by the first lens-element group can be coupled out.

In this refinement, between the first lens-element group and the displaceable second lens-element group there is a defined minimum distance that cannot be undershot by the second lens-element group. The clearance makes it possible to accommodate a beam splitter in the optical beam path and/or to introduce the chromatic assembly into the objective between the first lens-element group and the second lens-element group, which makes it possible to couple light in or out “very far at the front”. The refinement increases the flexibility of the new objective since, in particular, it also facilitates the coupling-in of defined illuminations for different sensor principles.

In further exemplary embodiments, a stripe pattern or some other structured illumination can be coupled in via the further interface, and is analyzed for example on the basis of the image captured by the camera in order to measure a measurement object. Preferably, a further clearance is provided between the fourth lens-element group and the light exit opening of the objective, a beam splitter likewise being arranged in said further clearance. A third interface is preferably arranged at the level of the further beam splitter, such that the input and output coupling of illumination and/or signals is also possible downstream of the optical system comprising the four lens-element groups. The flexibility and the scope of use of the new objective and of the corresponding coordinate measuring machine are thus increased even further.

In a further refinement, the objective has a separate cover glass, which is arranged upstream of the first lens-element group in the region of the light entrance opening.

In this refinement, light which enters into the beam path of the objective via the light entrance opening firstly impinges on the cover glass and only afterwards passes through the series of lens-element groups to the light exit opening. The arrangement of a separate cover glass upstream of the first lens-element group is an unusual measure for measurement objects since the cover glass in any case influences the optical properties of the objective or the beam path thereof. In the preferred exemplary embodiments, the optical properties of the cover glass are therefore taken into account in the correction of the lens-element groups, that is to say that the cover glass is included in the overall correction of the objective. The provision of a separate cover glass upstream of the first lens-element group is unusual particularly if the first lens-element group is designed for generating a defined longitudinal chromatic aberration, which is the case in preferred exemplary embodiments of the new objective. However, the refinement has the advantage that a separate cover glass can be more easily cleaned and exchanged, if appropriate, if the light entrance opening of the objective is soiled or even damaged during everyday operation. Accordingly, the new objective in preferred exemplary embodiments is designed such that the separate cover glass is held reversibly and non-destructively releasably in the objective body.

In a further refinement, the first, second, third and fourth lens-element groups in each case consist of at least two lens elements. In the preferred exemplary embodiments, each lens-element group comprises at least one cement element, i.e. at least two individual lens elements in each of the four lens-element groups are connected permanently and over a large area along their optically active surfaces.

This refinement reduces the number of interfaces and therefore contributes to a high imaging quality over a large spectral operating range. In one preferred exemplary embodiment, the four lens-element groups merely form fourteen interfaces.

It goes without saying that the features mentioned above and those yet to be explained below can be used not only in the combination respectively indicated, but also in other combinations or by themselves, without departing from the scope of the present invention.

### BRIEF DESCRIPTION OF THE DRAWINGS

Exemplary embodiments of the invention are illustrated in the drawing and are explained in greater detail in the following description. In the figures:

FIG. 1 shows an exemplary embodiment of the new coordinate measuring machine in a view obliquely from the front,

FIG. 2 shows a schematic illustration of the objective from the coordinate measuring machine from FIG. 1,

FIG. 3 shows a sectional view of the lens-element groups of the objective from FIG. 2 in accordance with one preferred exemplary embodiment, wherein the lens-element groups are illustrated in five different operating positions representing different magnifications with the same operating distance in each case,

FIG. 4 shows a further sectional view of the objective from FIG. 2 with five different operating positions representing five different magnifications with a different operating distance from that in FIG. 3,

FIG. 5 shows a further sectional view of the objective from FIG. 2, the illustration showing the position of the lens-element groups along the optical axis with in each case the same magnification for five different operating distances,

FIG. 6 shows a schematic illustration of an exemplary embodiment of the apparatus,

FIG. 6a shows a schematic illustration of a further exemplary embodiment of the apparatus, and

FIG. 7 shows a schematic illustration of an influence of a transverse chromatic aberration on the spectral lines.

### DETAILED DESCRIPTION OF THE PREFERRED EMBODIMENTS

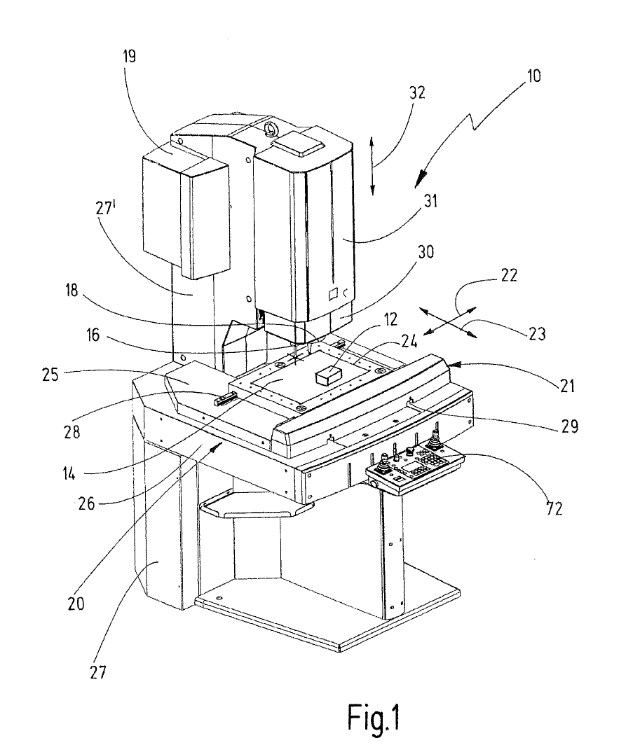

FIG. 1 shows an apparatus 10 for inspecting a measurement object 12 arranged on a workpiece carrier 14. In the embodiment illustrated, the apparatus 10 is a coordinate measuring machine. The measurement object 12 is measured by means of one or a plurality of optical sensors 18. Selectively, one or a plurality of tactile sensors 16 can additionally also be provided.

Coordinate measuring machines are generally known in the prior art. They are used, for example in the context of quality assurance, to check workpieces or to determine the geometry of a workpiece completely in the context of so-called “reverse engineering”. Furthermore, a wide variety of further application possibilities are conceivable, thus for example including the additional use for inspecting surfaces.

In such coordinate measuring machines, different types of sensors can be used to detect the coordinates of a workpiece to be measured. By way of example, sensors that effect tactile measurement are known for this purpose, such as are sold for instance by the applicant under the product designation “VAST”, “VAST XT” or “VAST XXT”. In this case, the surface of the workpiece to be measured is probed with a probe pin whose coordinates in the measurement space are continuously known. Such a probe pin can also be moved along the surface of a workpiece, such that in such a measuring process in the context of a so-called “scanning method” a multitude of measurement points can be detected at defined time intervals.

Furthermore, it is known to use optical sensors which enable the coordinates of a workpiece to be detected contactlessly. One example of such an optical sensor is the optical sensor sold by the applicant under the product designation “ViS-can”.

The sensors can then be used in various types of measurement setups. One example of such a measurement set-up is a table set-up, as shown in FIG. 1. One example of such a table set-up is the product “O-INSPECT” from the applicant. In such a machine, both an optical sensor and a tactile sensor are used to carry out different inspection tasks on one machine and ideally with a single clamping of a workpiece to be measured. In this way, many inspection tasks for example in medical technology, plastics technology, electronics and precision mechanics can be carried out in a simple manner. It goes without saying that, furthermore, various other set-ups are also conceivable.

Such sensor systems or sensor heads that carry both tactile and optical sensors are becoming increasingly important in coordinate measuring technology. A combination of tactile and optical sensors makes it possible to combine in a single coordinate measuring machine the advantages of the high accuracy of a tactile measuring system with the speed of an optical measuring system. Furthermore, calibration processes during sensor changes are avoided, as is possible reclamping of a workpiece.

Traditionally, the sensor head, which can also be designated as sensor system, is connected to a carrier system that supports and moves the sensor system. Various carrier systems are known in the prior art, for example gantry systems, stand, horizontal arm and arm systems, all kinds of robot systems and finally closed CT systems in the case of sensor systems operating with X-rays. In this case, the carrier systems can furthermore have system components that enable the sensor head to be positioned as flexibly as possible. One example thereof is the rotary-pivoting articulated joint from the applicant sold under the designation “RDS”. Furthermore, various adapters can be provided in order to connect the different system components of the carrier system among one another and to the sensor system.

Consequently, the use of the apparatus 10 and the coordinate measuring machine 100 are not restricted to the table set-up illustrated in FIG. 1 and the corresponding carrier system, but rather can also be used with all other types of carrier systems. Furthermore, the apparatus 10 can also generally be used in multi-sensor measuring systems or in a material microscope.

The apparatus 10 furthermore has a measuring table 20. A positioning device 21 is situated on the measuring table 20. Said positioning device is provided, in particular, for positioning the measurement object 12 parallel to an X-axis 19 and to a Y-axis 23. In this case, the X-axis 19 and the Y-axis 23 span a measuring plane.

By way of example, an X-table 24 and a Y-table 25 can be provided for positioning purposes. The X-table 24 is movable parallel to the X-axis 21 and the Y-table 25 is movable parallel to the Y-axis 19. Both are arranged on a baseplate 26. The baseplate 26 is carried by a machine frame 27 and 27′.

The movement of the X-table 24 and of the Y-table 25 is guided by linear guides in the X-direction 28 and in linear guides in the Y-direction 29. This set-up corresponds to the so-called “table set-up”. As already explained above, other carrier systems are also conceivable.

The apparatus 10 furthermore has a measuring head 15. One or a plurality of tactile sensors 16 can be arranged on the measuring head 15. Furthermore, the apparatus 10 is arranged on the measuring head 15. Furthermore, one or a plurality of further optical sensors 18 can also be arranged on or in the measuring head 15. The measuring head 15 therefore serves to couple the one or the plurality of optical sensors 18 and possibly a tactile sensor 16 to a carrier structure, for example a Z-slide 30. The measuring head 15 can be a closed housing construction, but it can also be embodied in an open fashion. By way of example, the measuring head 15 can also have the form of a simple plate on which the one or the plurality of optical sensors 18 and possibly the tactile sensor 16 are fixed. Furthermore, all further possible forms for coupling the one or the plurality of optical sensors 18 and possibly the tactile sensor 16 to the carrier structure are also conceivable.

The measuring head 15 is held on the Z-slide 30, which is guided in a slide housing 31 parallel to a Z-axis 32. Said Z-axis 32 is perpendicular to the X-axis 22 and to the Y-axis 23. The X-axis 22, the Y-axis 23 and the Z-axis 32 thus form a Cartesian coordinate system.

The apparatus 10 furthermore has an operating console 72. The individual elements of the apparatus 10 can be driven by means of the operating console 72. Furthermore, it is possible to predetermine inputs at the apparatus 10. In principle, it can also be provided that a display device (not illustrated) is arranged in the operating console 72 or elsewhere, in order to convey measurement value outputs to a user of the apparatus 10.

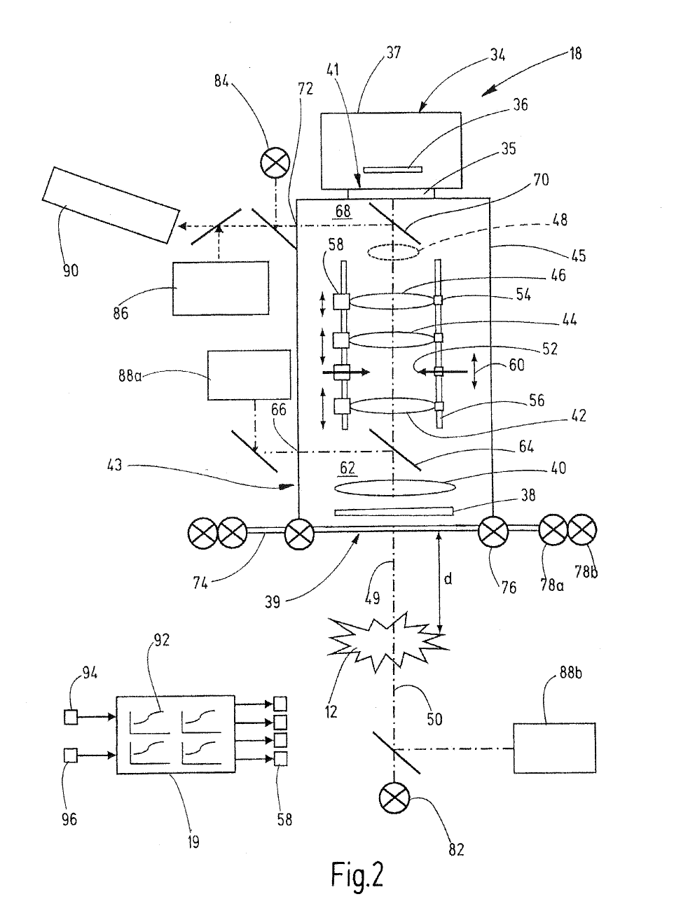

FIG. 2 shows an exemplary embodiment of the optical sensor 18, wherein the optical sensor 18 in this exemplary embodiment strictly speaking comprises a plurality of optical sensors which can be selectively present and used. The new objective can furthermore be combined with further optical sensors, for instance with a deflectometrically measuring sensor.

The sensor 18 comprises an objective 43 having an objective body 45. In typical exemplary embodiments, the objective body 45 is a tube having a light entrance opening 39 and a light exit opening 41, which are arranged at opposite ends of the tube. In principle, however, the objective body 45 can also have a form that deviates from a tube.

An interface 35 serving for connecting a camera 34 to an image sensor 36 is formed at the light exit opening 41. In preferred exemplary embodiments, the interface 35 is a standardized or widely used interface for coupling cameras and lenses, for instance a so-called F-mount or a so-called C-mount. In some exemplary embodiments, however, the interface 35 is a proprietary interface that makes it possible, in particular, to connect the housing 37 of the camera 34 directly to the objective body 45. In principle, it is also possible to use other standardized or proprietary interfaces for connecting the camera 34 to the objective body 45.

In the region of the light entrance opening 39, which defines the distal end of the objective 43, a cover glass 38 is arranged in the objective body 45 or on the objective body 45. In some exemplary embodiments, the cover glass 38 can be a screw-type glass that is screwed into a threaded mount at the distal end of the objective body 45. In other exemplary embodiments, the cover glass 38 can be pushed, clipped or adhesively bonded into a suitable cutout on the objective body 45 or can be connected to the objective body 45 in a positionally fixed fashion in some other way. In the preferred exemplary embodiments, the cover glass 38 is connected to the objective body 45 in such a way that a user of the coordinate measuring machine 10 can exchange the cover glass 38 without damaging the objective 43.

In the exemplary embodiment illustrated, the cover glass 38 is a wedge-shaped glass plate, the thickness of which increases from one edge to the other edge, as is illustrated in the simplified sectional illustration in FIG. 2. In this case, the cover glass 38 has a wedge angle chosen such that a reflection at the front side (towards the distal end of the objective 43) or the rear side of the cover glass 38 does not reach the image sensor 36 of the camera 34. In the exemplary embodiment illustrated, the cover glass 38 is arranged in such a way that its front side is inclined with respect to the light entrance opening 39, while the rear side is likewise arranged slightly obliquely with respect thereto. A tilting of the front and rear sides of the cover glass 38 with respect to an optical axis of the objective 43 avoids disturbing reflections.

In other exemplary embodiments, a cover glass having plane-parallel front and rear sides could be arranged slightly obliquely with respect to the image sensor 36 and/or the optical axis (explained in even greater detail below) of the objective 43.

In further exemplary embodiments, the cover glass 38 can be realized in the form of a thin film clamped in the region of the light entrance opening 39 of the objective 43. In some exemplary embodiments, the cover glass can be polarizing, such that the light passing through is polarized, and/or the cover glass can comprise a color filter for suppressing ambient light.

In the exemplary embodiment illustrated, a lens-element system having a first lens-element group 40, a second lens-element group 42, a third lens-element group 44 and a fourth lens-element group 46 is arranged between the cover glass 38 and the light exit opening 41 of the objective 43. In some exemplary embodiments, a fifth lens-element group is also arranged between the fourth lens-element group 46 and the light exit opening 41, said fifth lens-element group being represented here by dashed lines. The lens-element groups 40-48 are arranged in the objective body 45 one behind another between the light entrance opening 39 and the light exit opening 41 along a longitudinal axis 49 of the objective body 45. In the exemplary embodiment illustrated, a light beam that passes through the lens-element groups 40-48 in their respective middle or center experiences no deflection, such that the longitudinal axis 49 coincides with an optical axis 50 of the objective 43.

A diaphragm 52 is arranged between the second lens-element group 42 and the third lens-element group 44. In the preferred exemplary embodiments, the diaphragm 52 is an iris diaphragm, i.e. a diaphragm whose clear internal diameter can be varied.

The second, third and fourth lens-element groups 42, 44, 46 and the diaphragm 52 are in each case coupled to a dedicated slide 54 that can be moved along two guide rails 56. Furthermore, the three lens-element groups and the optical diaphragm 52 in this exemplary embodiment are in each case coupled to an electrical drive 58. With the aid of the drives 58, the second, third and fourth lens-element groups and the diaphragm 52 can be moved parallel to the optical axis 50, as is indicated on the basis of the arrows 60. In contrast thereto, the first lens-element group 40 and the optional fifth lens-element group 48 in the preferred exemplary embodiments are arranged in a stationary fashion in the objective body 45.

As can be discerned in FIG. 2, in some exemplary embodiments there is a clearance 62 between the first lens-element group 40 and the second lens-element group 42, said clearance remaining even if the second lens-element group 42 were positioned at a minimum distance with respect to the first lens-element group 40. In the preferred exemplary embodiments, a beam splitter 64 is arranged in the clearance 62 on the optical axis 50 in order selectively to couple in or out light from a further interface 66 of the objective 43. In the preferred exemplary embodiments, the second interface 66 is arranged approximately at the level of the beam splitter 64 on the lateral circumference of the objective body 45.

In a similar manner, in some exemplary embodiments of the objective 43, there is a further clearance 68, in which a beam splitter 70 is likewise arranged, between the fourth lens-element group 46 and the light exit opening 41. A further interface 72, via which light can be coupled in and/or out, is situated at the level of the beam splitter 70. In the exemplary embodiment illustrated, the beam splitter 70 is arranged between the fifth lens-element group 48 and the light exit opening 41. Alternatively or supplementarily thereto, the beam splitter 70 could be arranged between the fourth lens-element group 46 and the fifth lens-element group 48, which of course presupposes a corresponding clearance.

In preferred exemplary embodiments, the objective 43 has in the region of the light entrance opening 39 a holder 74, on which various light sources 76, 78 are arranged. In the exemplary embodiment illustrated, the holder 74 carries a ring light having a multitude of light sources 78a, 78b arranged all around the objective body 45 at different radial distances. In some exemplary embodiments, the light sources 78a, 78b are able to generate different-colored light, for instance white light, red light, green light and blue light and mixtures thereof. The light sources 78a, 78b can be used for producing different illumination scenarios at different distances in front of the light entrance opening 39. By way of example, the reference numeral 12 schematically indicates a measurement object 12 positioned at a distance d from the light entrance opening 39 of the objective 43. The distance d represents an operating distance between the objective 43 and the measurement object 12, wherein said operating distance can be set in a variable manner on the basis of the focusing of the objective 43.

In the present exemplary embodiment, the light sources 76 are light sources that are integrated into the objective body 45. In some exemplary embodiments, the light sources 76 are integrated into the objective body 45 outside the lens-element system, as is illustrated in FIG. 2. In other exemplary embodiments (alternatively or supplementarily), light sources 76 can be integrated into the objective body 45 in such a way that the light generated by the light sources 76 emerges from the objective body 45 at least through some of the lens-element groups and, if appropriate, the cover glass 38. In this case, the light entrance opening 39 is simultaneously also a light exit opening.

The light sources 76, 78 make it possible to illuminate the measurement object 12 in a variable manner in order selectively to generate bright-field and/or dark-field illumination. Both cases involve reflected light that impinges on the measurement object 12 from the direction of the objective 43.

Furthermore, in preferred exemplary embodiments, the coordinate measuring machine 10 has a further light source 82, which enables transmitted-light illumination of the measurement object 12. Accordingly, the light source 82 is arranged below the measurement object 12 or below the workpiece support of the coordinate measuring machine 10. In the preferred exemplary embodiments, therefore, the coordinate measuring machine 10 has a workpiece support 12 provided with a glass plate in order to enable the transmitted-light illumination.

Finally, the optical sensor 18 has a reflected-light illumination device 84, which can be coupled to the interface 72 via a further beam splitter. The light source 84 can couple light into the entire beam path of the objective 43 via the interface 72 and the beam splitter 70. The light coupled in is projected onto the measurement object 12 here via the lens-element system of the first to fourth (fifth) lens-element groups.

In the same way, different illuminations can be coupled into the beam path of the objective 43 via the interface 66 and, in principle, also via the light exit opening 41. By way of example, a grating projector is represented by the reference numeral 86. The grating projector generates a structured light pattern which is coupled into the beam path of the objective 43 via two beam splitters and the interface 72 in this exemplary embodiment. In some exemplary embodiments, a light source can be a laser pointer with which individual measurement points on the measurement object 12 can be illuminated in a targeted manner. In other exemplary embodiments, a light source can generate a structured light pattern, for instance a stripe pattern or grating pattern, which is projected onto the measurement object 12 via the lens-element system of the objective 43.

As is illustrated in FIG. 2, the objective 43 can be combined in various ways with optical sensors which serve for optically measuring the measurement object 12 alternatively or supplementarily to the camera 34. In FIG. 2, merely by way of example, a first confocal white light sensor 88a is coupled to the interface 66. Alternatively or supplementarily, a confocal white light sensor 88b can be coupled into the illumination path for the transmitted-light illumination 82 for example via a beam splitter. The sensors 88a and 88b can carry out a punctiform measurement. As will be explained below, a new type of optical distance measurement is proposed in the present case, however, using the clearance 62.

The reference numeral 90 designates an autofocus sensor, which can be used to determine the height position of the measurement object 12 parallel to the optical axis 50 on the basis of a determination of the focal position. Furthermore, an optical measurement of the measurement object 12 is possible with the aid of the camera 34 and a suitable image evaluation, as is known to the relevant persons skilled in the art in this field.

In the preferred exemplary embodiments, the objective 43 has a wide scope of use on account of the movable lens-element groups 42, 44, 46 and the adjustable diaphragm 52. In the preferred exemplary embodiments, a multitude of control curves 92 are stored in a memory of the evaluation and control unit 19 or some other suitable storage device. In the preferred exemplary embodiments, the multitude of control curves 92 form a 2D curve set which can be used to set the magnification and the focusing of the objective 43 in numerous freely selectable combinations. In the exemplary embodiment illustrated, a user can input a desired magnification 94 and a desired focusing 96 into the evaluation and control unit 19. With the aid of the control curves 92 and in a manner dependent on the desired magnification 94 and desired focusing 96, the evaluation and control unit 19 determines individual positions of the second, third and fourth lens-element groups along the optical axis 50 and an individual position and aperture of the diaphragm 52. In some exemplary embodiments of the new method, the user can vary the operating distance d from a measurement object by varying the focusing, without the sensor 18 having to be moved relative to the measurement object with the aid of the sleeve 14. By way of example, it is thus possible to measure structures on the surface of a measurement object 12 and structures at the bottom of a bore (not illustrated here) of the measurement object 12 by means of only the focusing of the objective 43 being varied, with constant magnification, such that in one case the structure on the surface of the measurement object 12 and in the other case the structure at the bottom of the bore lies in the focal plane of the objective 43.

In other variants, with a constant or changing operating distance d, which denotes a distance between the measurement object 12 and a first disturbing contour, namely the light entrance opening 39 of the objective 43, a user can vary the magnification of the objective 43 in order that, for example, details of a measurement object 12 previously measured “from a bird's eye view” are measured again.

Furthermore, in some exemplary embodiments, a user can vary the numerical aperture of the objective 43 by opening or closing the diaphragm 52 in order in this way to achieve a constant resolution with different operating distances d. Furthermore, a user can vary the magnification, focusing, numerical aperture individually or in combination with one another in order to optimally adapt the objective 43 to the properties of the different sensors 36, 88, 90.

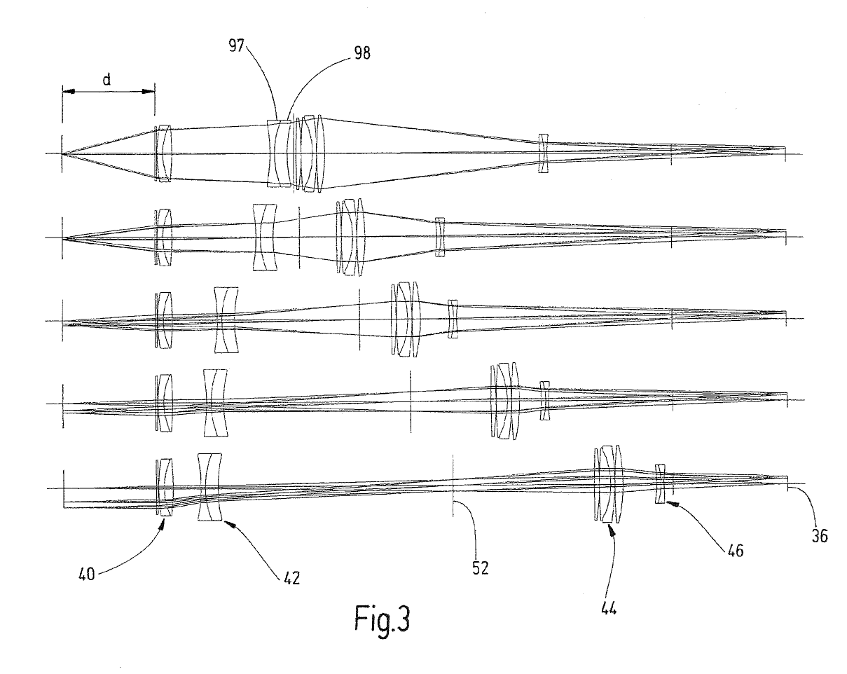

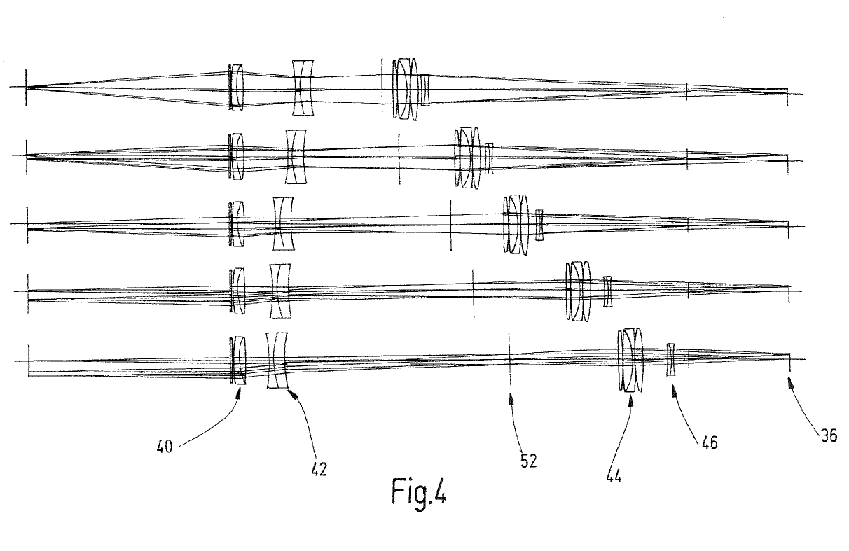

FIGS. 3 to 5 illustrate the positions of the lens-element groups 40, 42, 44, 46 and the position of the diaphragm 52 for different operating distances d and different magnifications. As can be discerned on the basis of the sectional views, each lens-element group has a plurality of lens elements 100, 102, wherein, in this exemplary embodiment, at least one cement element consisting of at least two lens elements 100, 102 is used in each lens-element group. Some of the lens-element groups have further separate lens elements. At a high magnification, the second and third lens-element groups are close together, wherein the actual distance between the second and third lens-element groups is additionally dependent on the operating distance d. As can be discerned on the basis of FIG. 3, the second and third lens-element groups are closer together in the case of a relatively small operating distance d than in the case of a relatively large operating distance.

With decreasing magnification, the second and third lens-element groups move apart from one another, the second lens-element group approaching the first lens-element group. At the high magnification, the first and second lens-element groups focus a (virtual) image formed by the measurement object upstream of the diaphragm 52. The fourth lens-element group acts as a projective system in this case. It shifts the image into the plane of the image sensor 36. With decreasing magnification, the image formed by the first and second lens-element groups moves further away from the diaphragm. The third and fourth lens-element groups approach one another and with joint positive refractive power image the virtual image onto the plane of the image sensor 36.

In all preferred exemplary embodiments, the diaphragm 52 in each case follows the focal point of the subsystem formed from the first and second lens-element groups. This enables a good field correction with the aid of the third and fourth lens-element groups.

In one preferred exemplary embodiment, a measurement object is arranged at a distance of between 0.8 and two times the focal length of the lens-element group 1. The first lens-element group has a positive refractive power. The second lens-element group has a negative refractive power. The third lens-element group has a positive refractive power, and the fourth lens-element group once again has a negative refractive power. The second, third and fourth lens-element groups are in each case achromatically corrected, while the first lens-element group produces a defined longitudinal chromatic aberration. The diaphragm 52 is situated in each case at the image-side focal point of the subsystem formed from the first and second lens-element groups. A corresponding control curve for the axial position of the diaphragm 52 ensures an object-side telecentricity. The change in the diaphragm diameter allows an object-side aperture adapted to the respective magnification and object structure. The virtual image formed by the first and second lens-element groups is imaged by the third and fourth lens-element groups to a defined location arranged at a defined fixed distance from the first lens-element group. In the preferred exemplary embodiments, the image sensor 36 is situated at said defined location.

The optional fifth lens-element group transforms the image by a constant absolute value with a scalar proportion of the total magnification. In the preferred exemplary embodiments, the total magnification is real without an intermediate image. The design of the system ensures, over the total magnification range, an exit pupil position relative to the image downstream of the fourth lens-element group between half and double the distance to the measurement object. This is advantageous in order to be able to couple illumination light into the objective 43 via the interface 72 and/or the interface 35 with low losses even without a strict image-side telecentricity.

The focal length of the subsystem formed from the first and second lens-element groups increases towards larger object fields and the diaphragm 52 tracks the lens-element groups moving in the direction of the image sensor 36. In this case, the beam heights at the third and fourth lens-element groups are limited on account of the diaphragm, which enables a good overall correction of the imaging. The overall system is underdetermined by the paraxial basic data of magnification, focusing, telecentricity and numerical aperture. With the aid of the control curve for the axial position of the diaphragm, it is possible to achieve a balanced correction of the image aberrations over a large adjustment range of the magnification. In some exemplary embodiments, the ratio between maximum magnification and minimum magnification is greater than 10 and preferably greater than 15.

In the preferred exemplary embodiments, the objective 43 can have transverse chromatic aberrations in order to enable a simple and cost-effective construction. This has the consequence that light and images of different colors can have a small offset transversely with respect to the optical axis 50. In preferred exemplary embodiments, the transverse chromatic aberration is corrected on the basis of mathematical correction calculations, which is possible in the preferred exemplary embodiments because the aberration image as such is continuous.

In some exemplary embodiments of the objective 43, the beam splitter 64 and the cover glass 38 are embodied such that a polarization-optical suppression with extraneous light is achieved. For this purpose, the beam splitter 64 is embodied as a polarizing beam splitter, and the cover glass 38 is a λ/4 plate. In this way, light that arises for example as a result of internal reflections in the objective body is deflected by the beam splitter 64. Only light that passed with outgoing and return path through the λ/4 plate was rotated in each case by 45° in the direction of polarization and can then pass through the beam splitter 64 by virtue of the direction of polarization rotated by 90° in total in the direction of the camera 34.

In preferred exemplary embodiments, mount parts of the lens-element groups are blackened, and the lens-element interfaces are provided with antireflection coatings. Interfaces of adjacent lens elements are cemented as much as possible. The individual assemblies are weight-optimized in order to enable rapid movements of the movable lens-element groups and diaphragm.

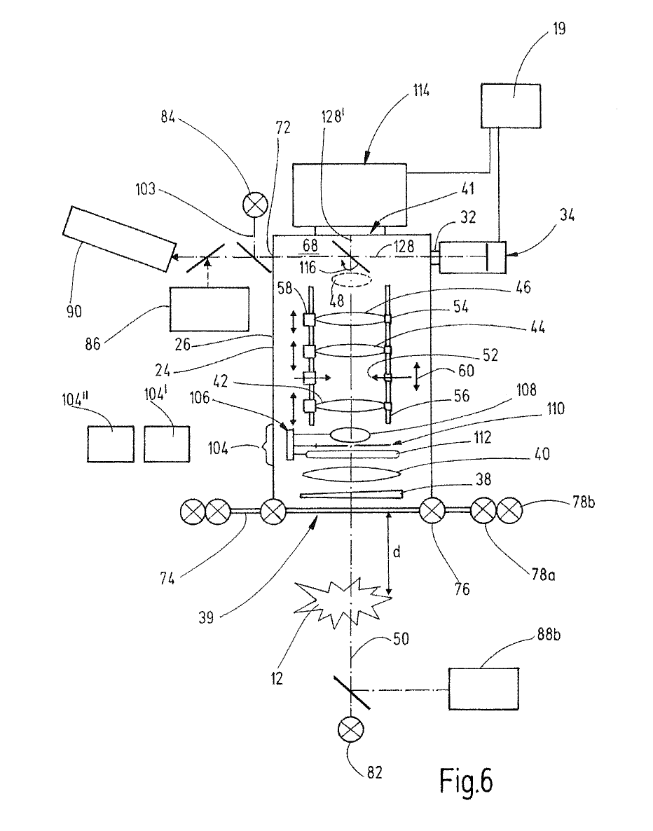

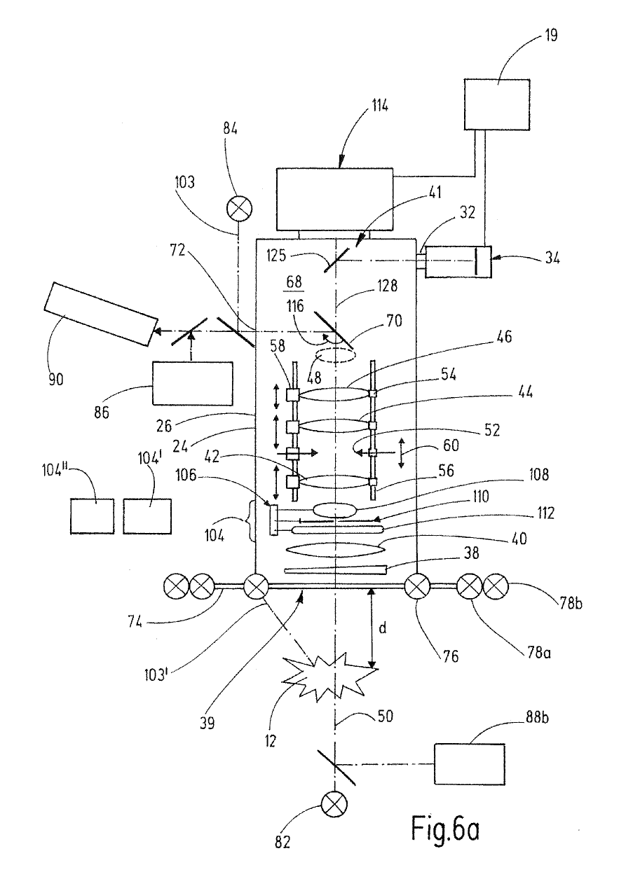

FIG. 6 shows how, in one embodiment of the apparatus 10, the optical sensor can be configured, particularly if a confocal white light sensor providing an areal detection or a linear detection is intended to be provided, and can be operated in particular in a so-called “scanning mode”. In this case, elements identical to those in FIG. 2 are identified by identical reference signs and will not be explained again below. Only the differences or additions are discussed below. A corresponding illumination beam path is designated by the reference sign 103. A further possible illumination beam path is designated by the reference sign 103′. An imaging beam path is designated by the reference sign 128. A further possible imaging beam path is designated by the reference sign 128′. In sections, in particular within the objective 43 or between the lens-element groups 40 to 48, the illumination beam path 103 and the imaging beam path 128 and/or 128′ can coincide.

The apparatus has a chromatic assembly 104. While the lens-element groups 40, 42, 44, 46, 48 in each case by themselves are corrected with regard to their longitudinal chromatic aberration, a specific predefined or defined longitudinal chromatic aberration can be introduced into the beam path of the objective 43 in a targeted manner by means of the chromatic assembly 104. By way of example, it is possible to pivot the chromatic assembly 104 laterally into the objective body 45 or the objective 43. In principle, it can be provided that a plurality of chromatic assemblies are present, which are indicated schematically by the reference signs 104′ and 104″. By way of example, it can be provided that an assembly carrier 106 is designed as a magazine. The latter can enable optional pivoting of one of the chromatic assemblies 104, 104′ and 104″ into the objective 43. In principle, the at least one chromatic assembly 104, 104′, 104″ can also be coupled into the illumination beam path 103 or the imaging beam path 128, 128′ at a different location. By way of example, this can also be effected in the region of the further interface 72, in particular at a light exit opening 41, or at the location at which the fifth lens-element group 48 is illustrated schematically. In particular, the at least one chromatic assembly 104, 104′, 104″ can be introducible into the illumination beam path 103 or the imaging beam path 128, 128′ on the image side of the multitude of lens-element groups 40 to 48.

The chromatic assembly 104 can have one or a plurality of refractive optical elements 108, for example lens elements. Furthermore, it can be provided that the chromatic assembly supplementarily or cumulatively has a slit diaphragm 110. A slit width of the slit diaphragm 110 can be adjustable. In this way, it is possible to optimize the measurement settings in particular for short measurement times and a required resolution. Supplementarily or cumulatively, at least one diffractive optical element 112 is likewise conceivable. These can in each case be held by the assembly carrier 106 and be introducible together with the latter into the objective 43.

In this way, it is possible to illuminate the measurement object 12 with a targeted longitudinal chromatic aberration by means of the reflected-light illumination device 84. Alongside the illustrated position of the reflected-light illumination device 84, other positions are also conceivable. For instance, a light from the chromatic reflected-light illumination device 84 can also be coupled in between the first lens-element group 40 and the second lens-element group 42 in such a way, for example by means of a mirror of a beam splitter, that the light from the reflected-light illumination device 84 only passes through the chromatic assembly 104 and the first lens-element group 40. However, provision can also be made, as illustrated, for the reflected-light illumination device 84 to send radiation through the entire objective 43, in order in this way to be able to use the beam shaping possibilities of the objective 43.

As can be discerned in FIG. 6, the arrangement of the camera 34 and of a spectrometer 114 is also chosen differently than that in FIG. 2. The camera 34 is offset relative to the schematic illustration illustrated in FIG. 2. A sensor area of the camera 34 does not extend perpendicular, but rather parallel to the longitudinal direction 49. In this way, it becomes possible to direct the incident light both onto the camera 34 and onto the spectrometer 114 by means of the beam splitter 70. As has already been mentioned above, the camera 34 can, however, in principle also be such a camera which can supply spectral information for each of its pixels. In this case, a spectrometer 114 in addition to the camera 34 would be unnecessary. However, a separate arrangement is provided in the exemplary embodiment illustrated. In principle, the arrangement around the further clearance 68 should be understood to be three-dimensional. The beam splitter 70 can be pivotable, as indicated by an arrow 160, in order that different optical elements from among the optical elements arranged around the further clearance 68 are coupled selectively individually or jointly or in part jointly into the beam path of the objective 43. In the illustration illustrated, the beam splitter 70 is used to couple in the light from the reflected-light illumination device 84 and at the same time to enable a detection by means of the spectrometer 114. The white light sensor described here can be embodied in this way.

In the case of a detector that effects measurement chromatically areally, such as can be provided by a camera 34 that provides a spectral evaluation for each of its pixels, images having the size of the field of view of the camera 34 are advantageously always measured. If larger regions of the measurement object are intended to be viewed, the images of the camera 34 could then be combined by means of “stitching methods” generally known to the person of average skill in the art.

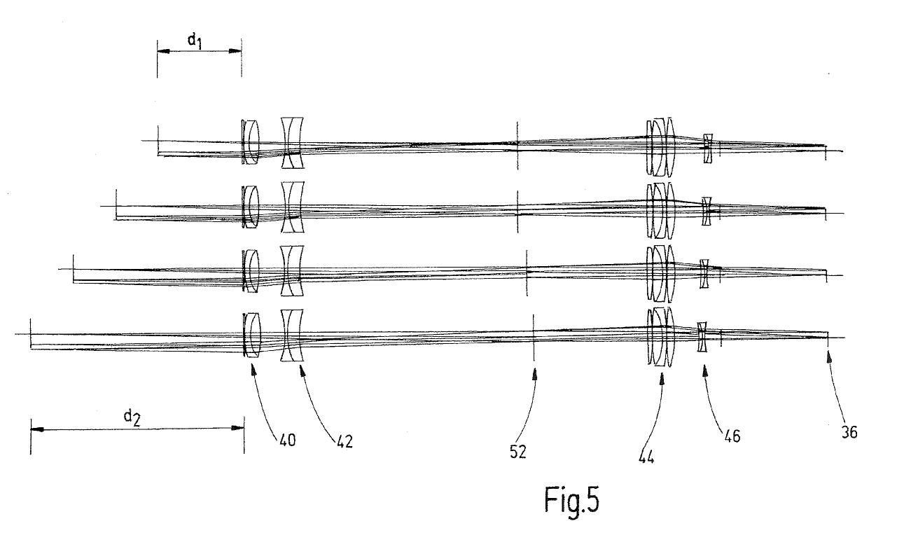

If the beam splitter 70 is pivoted by 180° relative to the position in FIG. 5, the light from the reflected-light illumination device 84 can be guided directly into the spectrometer 114 for example via a mirror on the rear side of the beam splitter. In this way, it is possible, for example, directly to measure the spectral distribution of the reflected-light illumination device 84 by means of the spectrometer 114 and to use it as a reference measurement. By means of the measurement result thus obtained, for example the light incident from the measurement object 12 on the spectrometer 114 through the objective 43 or the spectral distribution of said light could then be normalized in order to determine a corresponding maximum. In this way, changes in the reflected-light illumination device 84 can be detected and do not influence the evaluation. Furthermore, it is possible also to introduce a mirror at other locations in the objective 43, for example in the first clearance 62, in order that light emitted by the reflected-light illumination device 84 is reflected within the objective into the camera 43 or the spectrometer 114.

Alternatively, the spectrum of the light source 84 can also be concomitantly measured on a second channel of the spectrometer 114 in the case of a point-type sensor or in a second spectrometer (not illustrated). In the case of the line-like measurement presented here in FIG. 6, a multi-channel spectrometer 114 is employed, in which the reference spectrum can also be concomitantly measured e.g. at the edge. Temporal fluctuations would be concomitantly detected as a result. That would enable an optimum measurement accuracy. For the measurement, the measured spectrum would then be normalized to the reference spectrum. This then results in a quasi-relative reflection spectrum, from which it is possible to determine the position of one or even a plurality of surfaces in the operating range of the sensor on the basis of detected local maxima in the relative reflection spectrum.

In this case, the evaluation and control unit 19 can be coupled both to the camera 34 and to the spectrometer 114, in order to read out and process the corresponding evaluations or data. The correction of image aberrations during imaging onto the spectrometer, e.g. the orientation and/or the form of a measured spectrum, can likewise be effected by means of the evaluation and control unit. Optical elements can also be provided in the spectrometer 114 in order that such a correction is already performed optically as far as possible.

FIG. 6a illustrates a further embodiment of the apparatus 10. In this case, identical elements are identified by identical reference signs and are not explained again. In the exemplary embodiment illustrated, the apparatus 10 additionally has a further beam splitter 125. This makes it possible, in the illustrated position of the beam splitters 70 and 125, to use both the camera 34 and the spectrometer 114 together with the reflected-light illumination device 84. The image of the camera 34 can then be used, for example to determine information about the imaging quality.

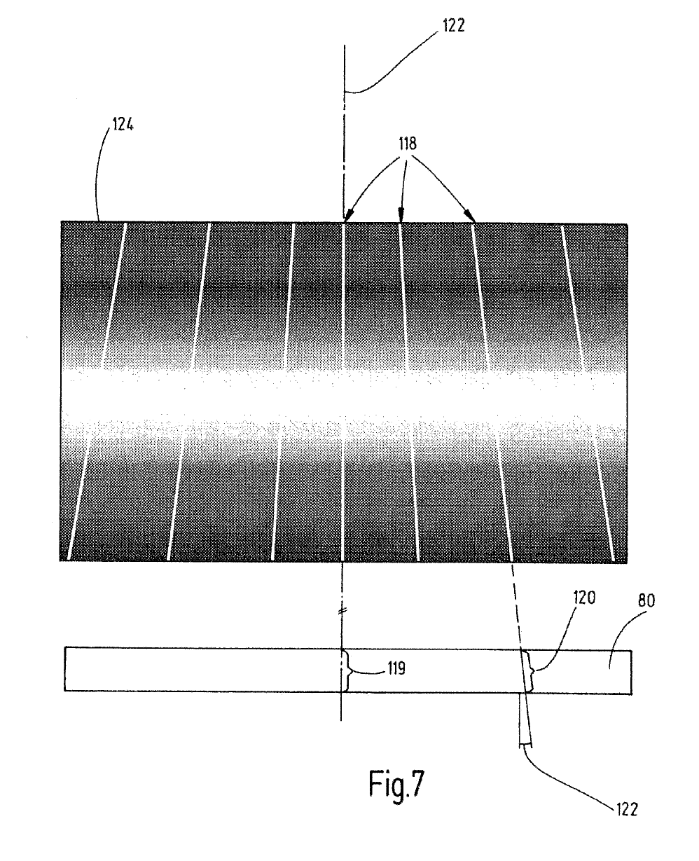

FIG. 7 schematically illustrates an effect of the apparatus in FIG. 5 which is associated with the transverse chromatic aberration of the objective 43 in the chromatic assembly 104. This has already been explained in the introductory part of the description, the objective 43 and the chromatic assembly 104 have a transverse chromatic aberration. That is to say that the spectral lines 118, in the entire detection region of a sensor, i.e. of the camera 34 and/or of the spectrometer 114, do not extend exactly parallel to a line 122 running perpendicular to the entrance slit of the sensor, but rather are inclined with respect to the line 122. An image 124 of the sensor that shows the spectral distribution and the position of the spectral lines 118 is illustrated by way of example. The spectral lines 118 represent the search lines along which the image 124 for a measurement point has to be searched for at least one intensity maximum.

Consequently, the different wavelengths of a pixel which belong together per se are focused with different lateral distances with respect to the optical axis 50 of the lens-element groups 40 to 48. Therefore, the focal points of the different wavelengths of the spectral range of an illuminated pixel are distorted not only along the longitudinal direction 39 as desired for bringing about the functionality of the white light sensor, but also transversely with respect to said longitudinal direction. The resultant “measuring direction” thus has an inclination with increasing radial distance. If this is not taken into account, it can have the effect that, for example, incorrect distances or items of depth information are determined in the case of a transmissive measurement object 12. In the case of a transmissive measurement object, two maxima are obtained in the reflected spectral range, one as a result of reflection at the front surface and one as a result of reflection on the rear surface. For measurement points imaged along the optical axis 50, a correct first distance 119, indicating the actual thickness of the measurement object 12, is always determined in this case. No transverse chromatic aberration is present along the optical axis 50. For other measurement points, a distortion can arise on account of the transverse chromatic aberration, such that maxima for other wavelengths are determined. If this were disregarded, it would have the effect that firstly an incorrect thickness of the measurement object 12, i.e. a second distance 120, is determined, which, however, does not correspond to the actual thickness of the measurement object 12. Furthermore, this can also have the effect that as a result the front or rear surface of the measurement object 12 is not determined as planar but rather as provided with a height contour.

A known transverse chromatic aberration of the overall system consisting of the chromatic assembly 104 and the objective 43 is determined by calibration on the basis of a measurement object 12 having a known geometry and is taken into account computationally in the evaluation of the image detected by means of the spectrometer 114 or the camera 34.

Occurring images which are not telecentric, for example, or other image aberrations, in particular distortion, coma or spherical image aberrations and the chromatic aberrations described above, can be corrected by methods of digital optics in the image processing. They are determinable by design or can be measured on the individual optics and then be filtered out in the image processing by convolution operations or are at least approximately subtracted by means of geometrical distortion correction. For the measurement using such a system, an adjustment is effected e.g. by means of a correction map or a set of parameterized curves which can be obtained by measurement of, for instance, the chromatic imaging properties in the field.

For this purpose, it is possible, for example, to capture a pixel at different object heights from the optical axis, on the one hand on the line in the image center parallel to the direction for example of the entrance slit of the spectrometer for the evaluation and on the other hand outside the line, in order to detect the properties of the imaging in the field as well. The properties can also be calculated or simulated for a system design, such that in a parametric model for the chromatic imaging properties it is then merely necessary to detect by measurement the specifics of the respective optical system at a small number of support points and the profiles can be gathered from the design. The profiles can then be fitted to the support points. FIG. 6 shows in this respect the simplest case of a linear dependence on longitudinal chromatic aberration and transverse chromatic aberration for the spectrum assumed here. In this case, by way of example, the set of parametric curves is the indicated, differently inclined curves, here straight lines. The inclination then increases here proportionally to the image height. Of course, functional dependencies with higher orders are also possible, that is to say quadratic or cubic and generally up to n-th order.

What is claimed is:

1. An apparatus for inspecting a measurement object, comprising a workpiece support for supporting the measurement object, and a measuring head carrying an optical sensor, wherein the measuring head and the workpiece support are movable relative to one another, wherein the optical sensor has an objective and a camera, which is designed to capture an image of the measurement object through the objective along an imaging beam path, wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, wherein at least two lens-element groups are displaceable parallel to the longitudinal axis, and wherein the apparatus has an illumination device for illuminating the measurement object along an illumination beam path, wherein the apparatus furthermore has a chromatic assembly, and wherein the apparatus is designed in such a way that the chromatic assembly can selectively be introduced into the illumination beam path and/or the imaging beam path.

2. The apparatus as claimed in claim 1, wherein each of the lens-element groups has in each case at least two lens elements, wherein each of the lens-element groups is corrected with regard to a longitudinal chromatic aberration, and wherein the chromatic assembly is configured in such a way that it brings about a defined longitudinal chromatic aberration.

3. The apparatus as claimed in claim 1, wherein the apparatus has at least four lens-element groups, wherein a first lens-element group from the at least four lens-element groups is arranged in a stationary fashion in the region of the light entrance opening, and wherein the diaphragm and a second lens-element group, a third lens-element group and a fourth lens-element group from the at least four lens-element groups are displaceable relative to the first lens-element group along the longitudinal axis, wherein the second lens-element group is arranged between the first lens-element group and the diaphragm, and wherein the third and fourth lens-element groups are arranged between the diaphragm and the light exit opening.

4. The apparatus as claimed in claim 1, wherein the chromatic assembly can be introduced between the first lens-element group and the second lens-element group.

5. The apparatus as claimed in claim 1, wherein the chromatic assembly can be introduced into the illumination beam path between a reflected-light illumination device and the multitude of lens-element groups.

6. The apparatus as claimed in claim 1, wherein the chromatic assembly has at least one refractive optical element, wherein the at least one refractive optical element is a spherical or cylindrical lens element.

7. The apparatus as claimed in claim 1, wherein the chromatic assembly has at least one diffractive optical element.

8. The apparatus as claimed in claim 7, wherein the apparatus furthermore has a cylindrical refractive optical element and/or a slit diaphragm in order to shape a beam of rays emitted by the reflected-light illumination device to a line focus.

9. The apparatus as claimed in claim 7, wherein a slit diaphragm together with the chromatic assembly can be introduced into the illumination beam path and/or the imaging beam path.

10. The apparatus as claimed in claim 7, wherein the reflected-light illumination device is an element of the chromatic assembly.

11. The apparatus as claimed in claim 1, wherein the camera is designed in such a way that it provides a spectral evaluation for each pixel.

12. The apparatus as claimed in claim 1, wherein the apparatus furthermore has a spectrometer and a beam splitter, which is arranged in the objective in such a way that it directs light incident through the objective both onto the spectrometer and onto the camera.

13. The apparatus as claimed in claim 1, wherein the apparatus has a plurality of chromatic assemblies, wherein a single one or more of the plurality of chromatic assemblies can selectively be introduced into the illumination beam path and/or the imaging beam path, and wherein each chromatic assembly is configured in such a way that it brings about a different longitudinal chromatic aberration.

14. The apparatus as claimed in claim 1, wherein the apparatus is a coordinate measuring machine and has an evaluation and control unit, which is designed to determine spatial coordinates at the measurement object in a manner dependent on a position of the measuring head relative to the workpiece support and in a manner dependent on sensor data of the optical sensor.

15. The apparatus as claimed in claim 1, wherein the apparatus has an evaluation and control unit, which is designed in such a way that it takes into account, during an evaluation, imaging aberrations that occur.

16. The apparatus as claimed in claim 15, wherein the image aberrations taken into account by the control unit are an inclination of spectral lines relative to the longitudinal axis, said inclination being brought about by a transverse chromatic aberration of the objective and of the chromatic assembly.

17. The apparatus as claimed in claim 6, wherein the chromatic assembly has a plurality of refractive optical elements constructed in the manner of a Kepler telescope or constructed in the manner of a Galilean telescope.
